(19) United States
(12) Patent Application Publication
(10) Pub. No.: US 2022/0118788 A1
(43) Pub. Date: Apr. 21, 2022

(54) BOOK PRODUCTION SYSTEM AND METHOD

(71) Applicant: Revival AI Inc., Parker, CO (US)

(72) Inventors: William John Robinson, III, Parker, CO (US); Kristin Nichol Robinson, Parker, CO (US)

(73) Assignee: Revival AI Inc.

(21) Appl. No.: 17/505,972

(22) Filed: Oct. 20, 2021

Related U.S. Application Data
(60) Provisional application No. 63/093,898, filed on Oct. 20, 2020.

(51) Int. Cl. B42C 11/04; B25J 11/00; B42C 9/02

(52) U.S. Cl. CPC B42C 11/04; B42C 9/02; B25J 11/005

(57) ABSTRACT

A method of making a customized book via a fully automated process. Various sized customized books are produced via an automated book production system. The automated book production system includes a book block finishing section for preparing a book block to be part of the customized book. The automated book production system also includes a cover finishing section for preparing a cover for the customized book. The book cover is made of a flexible material. The automated book production system further includes a customized book finishing section that combines the book block and the cover to create the customized book. A fully automated customized book production system includes the book block finishing section, the cover finishing section for preparing a cover for the customized book, and the customized book finishing section that combines the book block and the cover to create the customized book.

### CROSS-REFERENCE TO RELATED APPLICATIONS

The present application is a conversion of U.S. Provisional Application having U.S. Ser. No. 63/093,898, filed Oct. 20, 2020, which claims the benefit under 35 U.S.C. 119(e). The disclosure of which is hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to a book production system for automating the making of customized books in varying sizes, such as bibles, and a method for making the customized books.

### 2. Description of the Related Art

Typically, when a customized book, such as a leather-bound book, is created, it is either a one-off, or it is part of a single batch of books. Or, there are limited choices to choose from when requesting a customized leather-bound book. Furthermore, any current system that is used in making customized leather bound books involves several manual steps.

Accordingly, there is a need for a system and method that can be used to create customized books that is automated and can provide considerable variability, such as the book/page size and thickness, of the customized book.

### SUMMARY OF THE DISCLOSURE

The present disclosure is directed to a method of making a customized book via a fully automated process. Various sized customized books are produced via an automated book production system. The automated book production system includes a book block finishing section for preparing a book block to be part of the customized book. The automated book production system also includes a cover finishing section for preparing a cover for the customized book. The book cover is made of a flexible material. The automated book production system further includes a customized book finishing section that combines the book block and the cover to create the customized book.

The present disclosure is also directed to a fully automated customized book production system. The system includes the book block finishing section, the cover finishing section for preparing a cover for the customized book, and the customized book finishing section that combines the book block and the cover to create the customized book.

### BRIEF DESCRIPTION OF THE DRAWINGS

FIG. 1 is a perspective view of a portion of an automated book production system constructed in accordance with the present disclosure.

FIG. 2 is an exploded view showing the various parts of a book.

FIG. 3 is a perspective view of another portion of the automated book production system.

FIG. 4 is a perspective view of another portion of the automated book production system.

FIG. 5 is a perspective view of another portion of the automated book production system.

FIG. 6 is a perspective view of another portion of the automated book production system.

FIG. 7 is a perspective view of another portion of the automated book production system.

FIG. 8 is a perspective view of another portion of the automated book production system.

FIG. 9 is a perspective view of another portion of the automated book production system.

FIG. 10 is a perspective view of another portion of the automated book production system.

FIG. 11 is a perspective view of another portion of the automated book production system.

FIG. 12 is a perspective view of another portion of the automated book production system.

FIG. 13 is a perspective view of another portion of the automated book production system.

FIG. 14 is a perspective view of another portion of the automated book production system.

FIG. 15a is a perspective view of another portion of the automated book production system.

FIG. 15b is a perspective view of another portion of the automated book production system.

FIG. 16 is a perspective view of another portion of the automated book production system.

FIG. 17 is a perspective view of another portion of the automated book production system.

FIG. 18 is a perspective view of another portion of the automated book production system.

FIG. 19 is a perspective view of another portion of the automated book production system.

FIG. 20 is a perspective view of another portion of the automated book production system.

FIG. 21 is a perspective view of another portion of the automated book production system.

FIG. 22 is a perspective view of another portion of the automated book production system.

FIG. 23 is a perspective view of another portion of the automated book production system.

FIG. 24 is a perspective view of another portion of the automated book production system.

FIG. 25 is a perspective view of another portion of the automated book production system.

FIG. 26 is a perspective view of another portion of the automated book production system.

### DETAILED DESCRIPTION OF THE DISCLOSURE

The present disclosure relates to an automated book production system 10 and method for producing customized books 11. The automated book production system 10 is not shown in a single drawing. Rather, various parts of it are shown across multiple drawings. The customized books 11 can vary in length, width and thickness and can include any one of various book covers. The customized books can include any number of other customizations described herein. The book production system 10 can be configured to produce a customized book, such as a leather-bound book, for any book. For example, the book production system 10 can produce leather-bound bibles or classic books, such as Moby Dick or War and Peace. The book production system 10 can receive electronic orders for customized books made by individuals via a website. The orders for customized books can include the book desired, the colors and styles of the various parts of the book. The book production system 10 can include a book block finishing section 12 for preparing a book block 22 of the customized book, a cover finishing section 14 for preparing a customized cover of the customized book, and a customized book finishing section 16 for combining the book block and the customized cover of the customized book. Optionally, the book production system 10 can include a banding and boxing section for handling the customized book for after completion and a packaging and palletization section for handling of the boxed customized books in preparation of delivery or shipping.

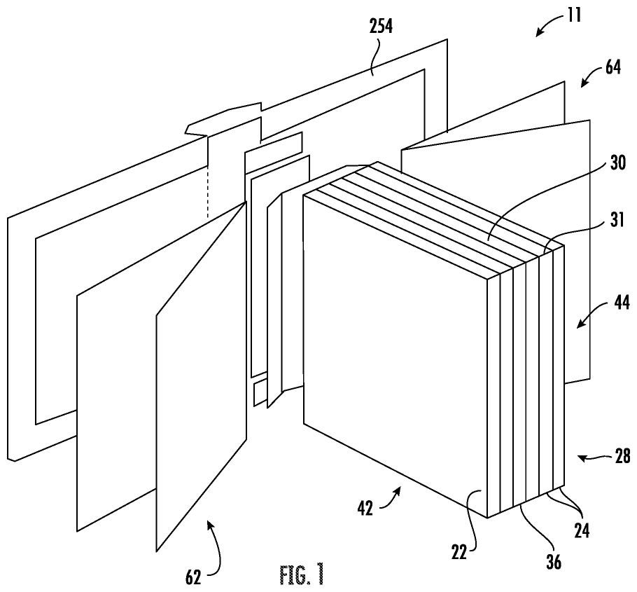

The method includes supplying the book block 22 to the book production system 10. Referring now to FIG. 1, a book block 22 is a collection of at least one folded signature 24 or multiple folded signatures 24 secured together as a gathered signature or an inserted signature. The book block 22 can be sewn together, glued, PUR-bound, etc. The book block 22 has a bound side where the signatures 24 are sewn together, a front end 28 opposite the bound side, a top end 30 and a bottom end. The front end 28, top end 30 and bottom end 32 define the edges of the pages of the book block 22, and eventually the customized book 11. The book block 22 also includes a first outer corner 34 where the top end 30 of the book block 22 and the front end 28 of the book block 22 intersect and a second outer corner 36 where the front end 28 of the book block 22 intersects the bottom end of the book block 22. The book block 22 can be delivered to the book production system 10 from a book sewing machine or book gluing machine.

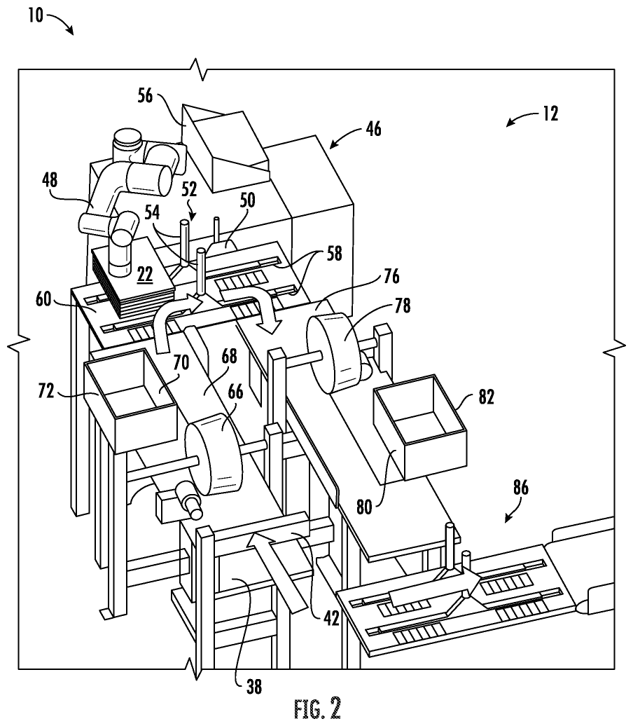

The book block 22 can be delivered to the book production system 10 via any means known to one of ordinary skill in the art such as via a conveyor 38. Referring now to FIG. 2, the book block finishing section 12 can include a lift gate 40 that can raise and lower to permit the book block 22 access to the book block finishing section 12.

The book block 22 can have a protective cover page placed on the front 42 of the book block 22 and a protective back page disposed on the back 44 of the book block 22 by a protective page system 46. The protective page system 46 can include a robotic arm 48 that can retrieve the protective page (back or cover) move the protective page to engage with a glue applicator 50 and forcing the protective page to the front 42 of the book block 22. A rotator device 52 including a plurality of arms 54 can be rotated to flip the book block 22. The robotic arm 48 can retrieve a second protective page a protective page holder 56, force the second protective page to engage the glue applicator and then force the second protective page onto the back 44 of the book block 22. The rotator device 52 can be disposed in slots 58 in a table 60 where the book block 22 can be flipped from one side of the table to the other. The protective cover page and the protective back page are used to protect the book block 22 as it passes through the book production system 10.

In one embodiment, a front end sheet 62 can be inserted by the book production system 10 between the protective cover page and the first page of the book block 22. Similarly, a back end sheet 64 can be inserted by the book production system 10 between the protective back page and the last page of the book block 22. To accomplish insertion of the front end sheet 62 and the back end sheet 64, the book block 22 can be fed to a vacuum roller 66 via a first conveyor 68 of the book block finishing section 12. The vacuum roller 66 is disposed above the first conveyor 68 and lifts the desired amount of pages (could be just a single page, such as a protective page) of the one side of the book block 22. While the desired number of pages are held up, the book block 22 is moved where a first guide plate 70 maintains position of the raised pages and an end sheet 62 or 64 is transferred from a first box 72 to between the raised pages and the book block 22 via a first belt drive. Once the end sheet 62 or 64 is inserted, the first conveyor 68 will move the book block 22 past the first guide plate 70 and the raised pages will fall back on the book block 22.

If desired, the book block 22 (after being flipped by the rotator device 52, which can be used with our without providing protective pages to the book block 22) can be directed to a second conveyor 76 where a second end sheet 62 or 64 (depends on which end sheet was incorporated into the book block 22 first) can be inserted. The second conveyor 76 moves the book to a second vacuum roller 78 disposed above the second conveyor 76 and lifts the desired amount of pages (could be just a single page, such as a protective page) of the one side of the book block 22. While the desired number of pages are held up, the book block 22 is moved where a second guide plate 80 maintains position of the raised pages and an end sheet 62 or 64 is transferred from a second box 82 to between the raised pages and the book block 22 via a second belt drive. Once the end sheet 62 or 64 is inserted, the second conveyor 76 will move the book block 22 past the second guide plate 80 and the raised pages will fall back on the book block 22. The book block finishing section 12 can also include a second rotator device 86 to be used to flip the book block 22 if it is desired to have the book block 22 in a different position after the end sheets 62 or 64 are inserted. At one point in the process, the front end sheet 62 and the back end sheet 64 are taken out of the book block 22 and secured to the inside of the front of the book cover and the inside of the back of the book cover, respectively. The end sheets 62 and 64 are inserted in the book block 22 so that the end sheets 62 or 64 are subjected to the same treatment as the other pages of the book.

In another embodiment, no protective cover pages are employed and the front end sheet 62 can be inserted between the first and second pages of the book block 22 and the back end sheet 64 can be inserted between the last and second to last pages of the book block 22. Depending upon the setup of the book production system 10, the first page of the book block is lifted by the book production system 10 so that the front end sheet 62 can be inserted in the book block 22. The book production system 10 can also lift the back page of the book block 22 and insert the back end sheet 64 into the book block 22. It should be understood and appreciated that the front end sheet 62 and the back end sheet 64 can be inserted into any portion of the book block 22 so that they have the same customization as the other pages of the customized book and can be retrieved to be secured to the inside of the front of the book cover and the inside of the back of the book cover, respectively.

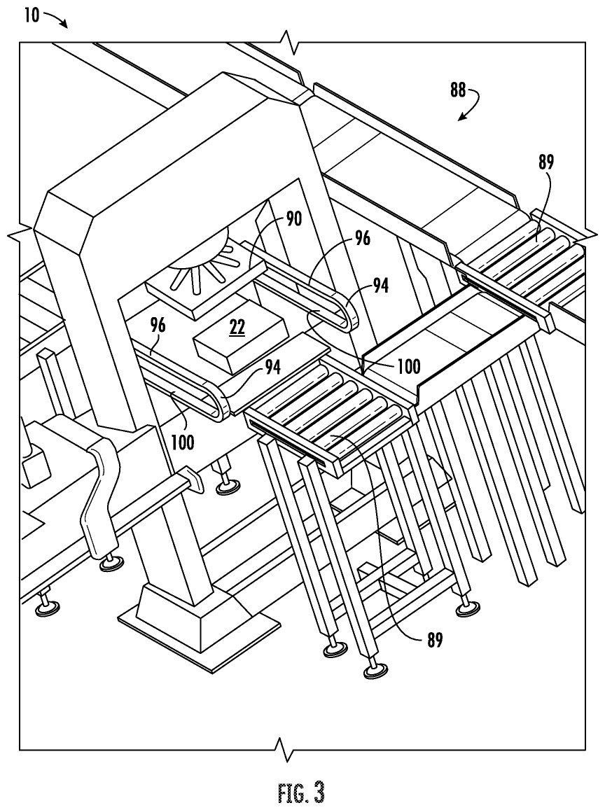

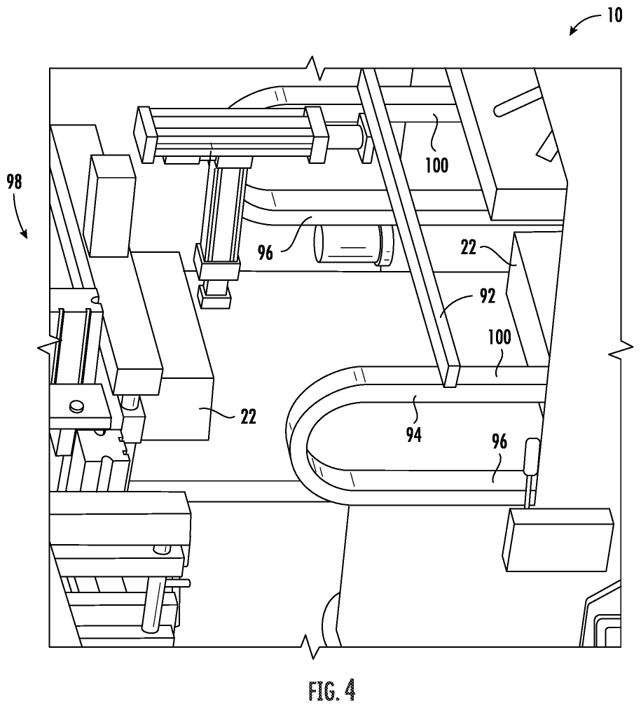

After the front end sheet 62 and the back end sheet 64 are inserted into the book block 22, the book block 22 is then sent to a book press 88 of the book block finishing section 12 where the book block is subjected to an extremely high pressure that vertically compresses the book block 22 to remove any air captured between the pages. Referring now to FIGS. 3 and 4, the book block 22 can be directed to the book press 88 via any means known in the art, such as gates to prevent movement in one direction, pusher devices (e.g., air cylinder) to move the book block 22 in a desired direction and conveyors to deliver the book block 22 to the book press 88 and away from the book press 88. Further, the book production system 10 can include mechanized rollers 89 to move and position the book block 22 at a desired location in the book production system 10.

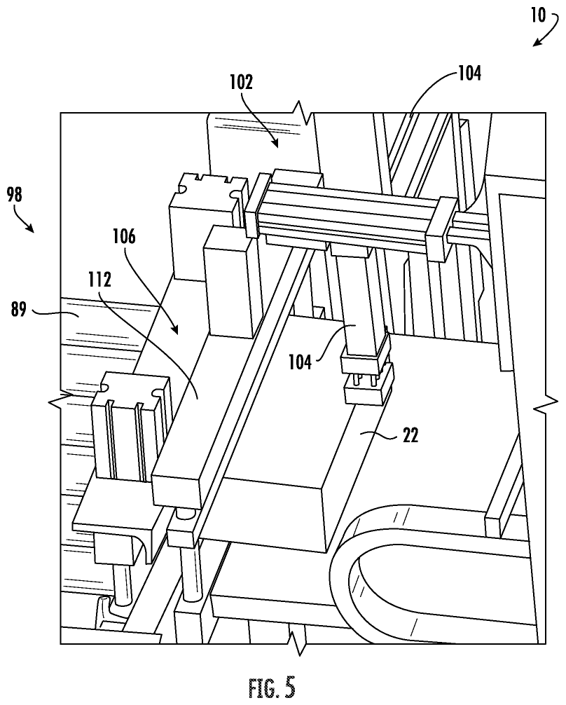

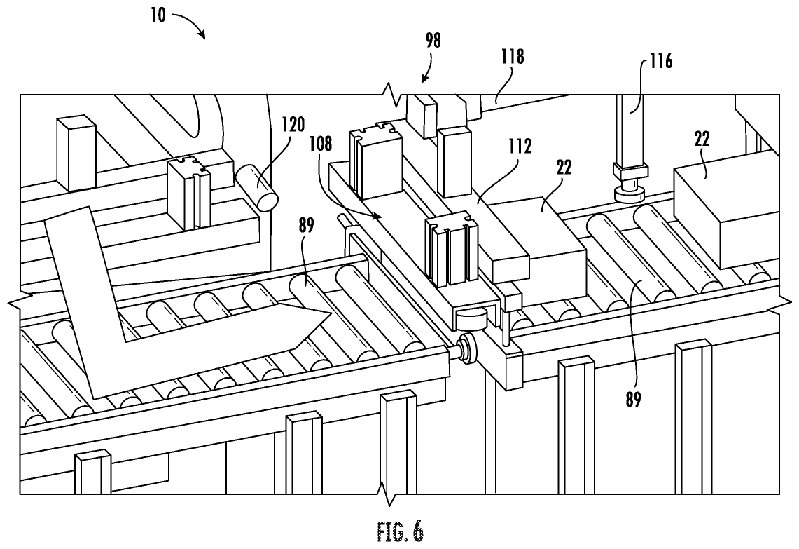

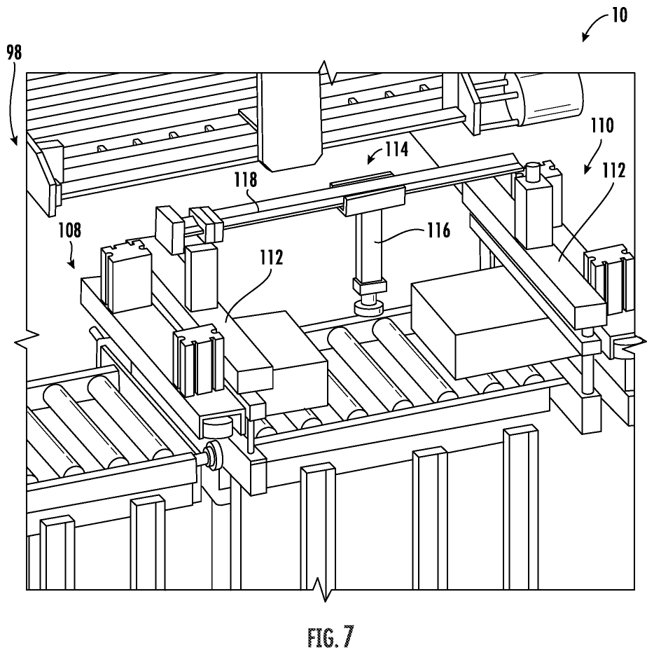

The book press 88 can include a plate 90 that is driven downward on the book block 22. The plate 90 can be driven by any means known in the art, such as hydraulically or pneumatically. A cross-bar 92 can be used to engage the book block 22 and force it into and out of position with respect to the book press 88. The cross-bar 92 is driven by mechanical means which would be obvious to one of ordinary skill in the art. The cross-bar 92 can be driven by a chain conveyor 94 that operates on a loop. When the cross-bar 92 is on the lower track 96 of the chain conveyor 94, the cross-bar 92 moves the book block 22 into position under the book press 88. Referring now to FIGS. 5-7, after compression of the book block 22, the cross-bar 92 moves the book block 22 to a cutting station 98. After delivery of the book block to the cutting station 98, the cross-bar 92 transitions on the loop to an upper track 100 of the chain conveyor 94 where the cross-bar 92 travels back under the plate 90 of the book press 88, back down to the lower track 96 and is positioned behind another book block to be directed to the book press 88.

Once the air has been compressed, the book production system 10 can retain the book block dimensions for the rest of the process the book block 22 undergoes. Additionally, the book production system 10 can assess the book block 22 at various stages of the process to make sure the quality of the book block 22 is at a desired level. If the book block 22 is not at, or above, the desired quality, the book block 22 can be removed from the book production system 10.

The cutting station 98 can include a placement device 102, which can be a plurality of cams 104 that cooperate to position the book block 22 in a desired location with respect to a guillotine apparatus 106 where the front end 28 of the book block 22 is precisely cut to provide a specific width to the pages of the book block 22. The guillotine apparatus 106 can also cut the top end 30 and the bottom end 32 of the book block 22 to cause the pages of the book block 22 to have a certain length. In one embodiment, the cutting station 98 can include a second guillotine apparatus 108 to cut the top end 30 of the book block 22 and a third guillotine apparatus 110 to cut the bottom end 32 of the book block 22. The cutting station 98 can also include a clamp device 112 for each guillotine apparatus 106, 108, 110 incorporated by the book production system 10 to apply downward force and hold the book block 22 securely in position while the ends are cut. In one embodiment, the book production system 10 can simultaneously cut the top and bottom ends 30 and 32 of the book block 22. The cuts made to the front end 28, top end 30 and the bottom end 32 cause the first and second outer corners 34 and 36 to be squared. The book production system 10 can be configured to cut one end of one book block 22 with the second guillotine apparatus 108 at the same time another end of another book block 22 is cut with the third guillotine apparatus 110. A second placement device 114 can be incorporated to position the book block 22 and desired locations relative to the second and third guillotine apparatuses 108 and 110. The placement device 114 can use a cam 116 mounted to a slide rail 118 to position the book block 22. Sensors 120 can be positioned at various locations throughout the book production system 10 to confirm and notify the book production system 10 that the book block 22 is in the correct location/position.

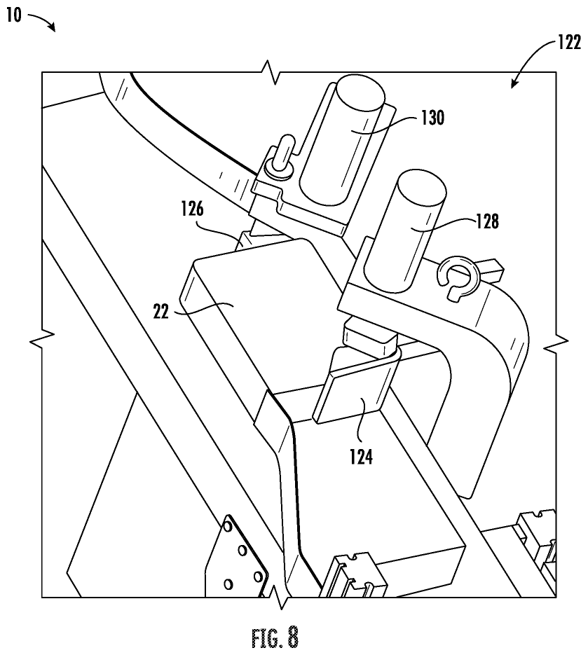

Referring now to FIG. 8, the book production system 10 can include a corner punch station 122 to cut a rounded corner on the first and second outer corners 34 and 36 of the book block 22. The corner punch station 122 includes a first corner guide 124 and a second corner guide 126 for receiving the first outer corner 34 and the second outer corner 36, respectively. The corner guides 124 and 126 can move independently so as to accommodate different book sizes. The book block 22 can be stopped on the conveyor by a horizontal plate and forced into the first and second corner guides 124 and 126. Curved blades are forced downward by blade drivers 128 and 130 to cut rounded corners for the first and second rounded corners 34 and 36. The blade drivers 128 and 130 can be powered by hydraulics, pneumatics or any other manner known in the art.

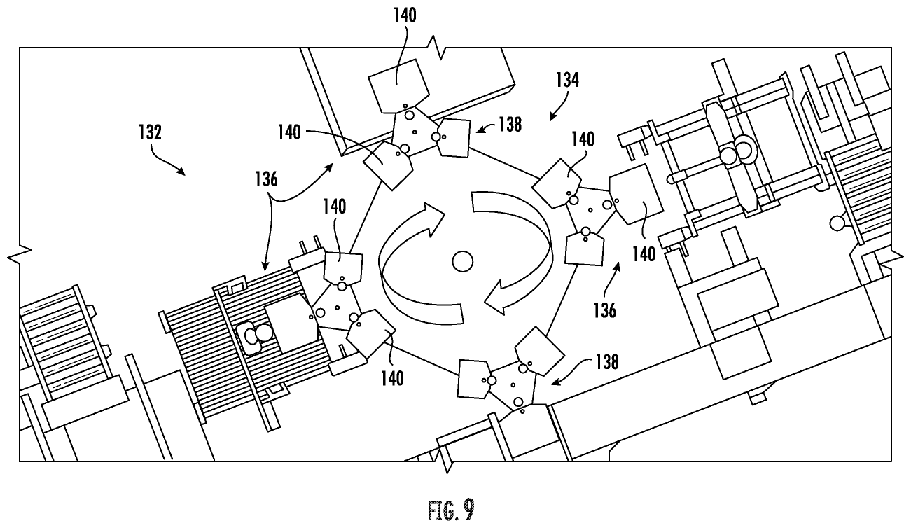

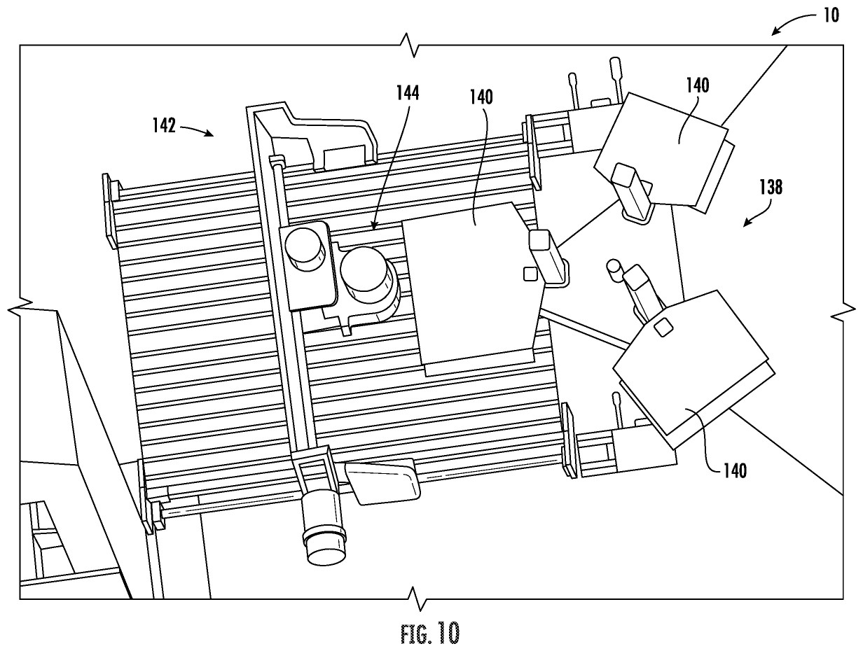

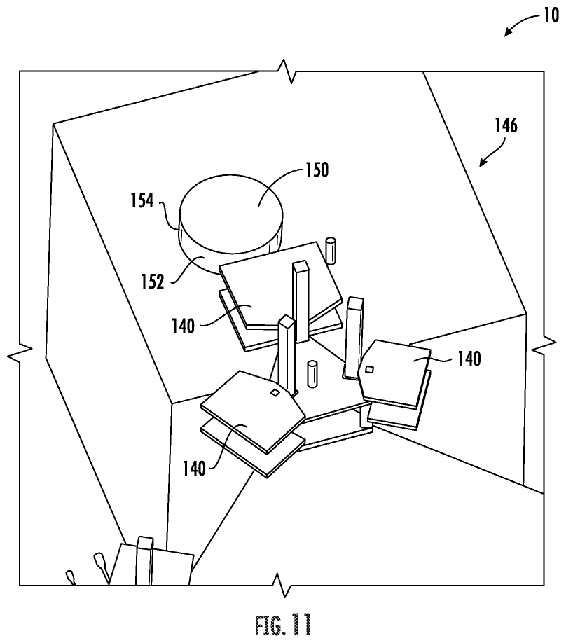

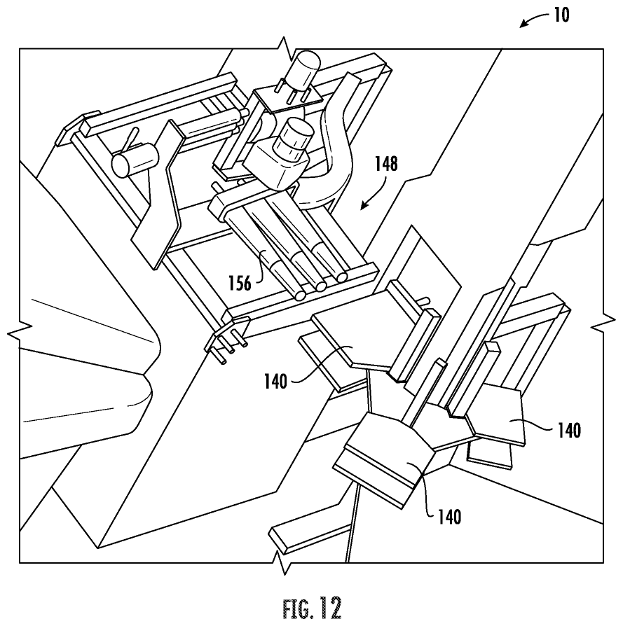

Referring now to FIG. 9-12, once the book blocks 22 are cut and the corners 34 and 36 of the pages are rounded, they are sent to a page edge finishing apparatus 132. The page edge finishing apparatus 132 includes a carousel table 134 for providing the book block 22 to various finishing stations 136 to provide desired qualities to the customized books. The page edge finishing apparatus 132 can accommodate a variety of different size book blocks 22. A sensor can be used to determine the size of the book block 22 prior to the book block 22 entering the page edge finishing apparatus 132. The book block 22 is provided to a distributor apparatus 138 that delivers the book block 22 to each finishing station 136. The distributor apparatus 138 can have multiple sized clamp plates 140 that can secure the book block 22 there between while the book block 22 is distributed to the finishing stations 136. The appropriate sized clamp plates 140 are selected after the sensor determines the size of the book block 22 so that the edges of the pages are properly exposed to each finishing station 136. The carousel table 134 can have multiple distributor apparatuses 138 so book blocks 22 can be provided to multiple finishing stations 136 at the same time. After a book block 22 is fed to a distributor apparatus 138, the carousel table 134 rotates and moves the book block 22 to the first finishing station 136.

The first finishing station 136 is a sanding station 142. The sanding station 142 can apply multiple grits of sand paper to smooth the edges (top edge, bottom edge and the front edge) of the pages to a desired smoothness. In one embodiment, the sanding station 142 can apply four separate levels of increasing sandpaper grit (i.e., from a course grit up to a fine grit sandpaper) to give the page edges the desired smoothness. The sanding station 142 can include a vacuum apparatus to remove the sanding debris that is created when the page edges are sanded. In one embodiment of the present disclosure, the book block 22 is supplied to the sanding station 142 with squared corners and the rounded corners can be done with sandpaper during the sanding process. The sanding station 142 can have a sanding apparatus 144 that holds and moves the sandpaper. Multiple sanding apparatuses 144 can be used where each sanding apparatus 144 uses a different grit sandpaper. Each sanding apparatus 144 can be changed out automatically. The sanding station 142 can move the sanding apparatus 144 around the edges of the book block 22. The movement of the sanding apparatus 144 is computer-controlled and provides a high-precision finish on a digital path.

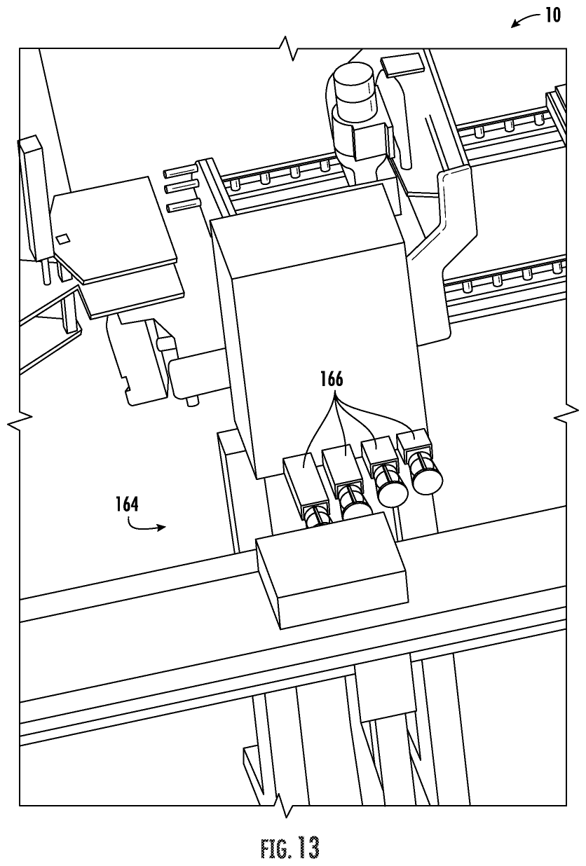

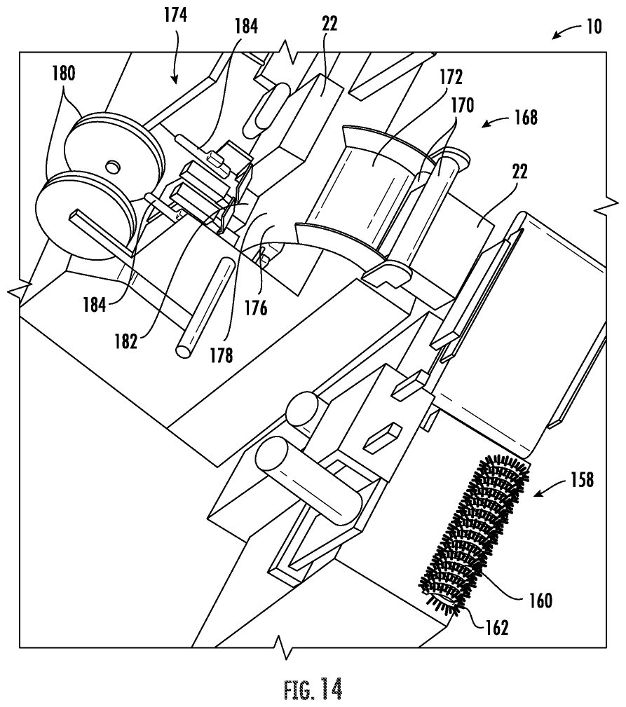

The page edge finishing apparatus 132 can also include additional finishing stations 136, such as a gilding station 146 that applies gilding to the page edges and a painting apparatus 148 for spraying the edges of the pages with an ink. The gilding station 146 can include at least one application wheel 150 with tape 152 disposed around the sides 154 of each application wheel 150 to provide the gilding to the page edges of the book block 22. The gilding applied to the page edges permits the ink sprayed on the pages to be done properly. The painting apparatus 148 can include a variety of colors for the paint or ink applied to the page edges. The ink sprayed on the edges of the paper can be chosen from a variety of colors the book production system 10 offers. The painting apparatus 148 can include sprayers 156 that can distribute the paint to the page edges. After the gilding and the painting is done, the book blocks 22 are removed from the page edge finishing apparatus 132 and conveyed to a page fanner 158 (see FIG. 14) to fan the pages of the book block 22 to separate the pages and prevent the pages from sticking together from the gilding and painting process. The page fanner 158 can include a horizontally disposed brush 160 that is spun as the book block 22 passes the brush 160. In one embodiment, the brush 160 can have soft bristles 162 that are provided in a helical pattern thereon. After passing the page fanner 158, the book block 22 is provided to a gluing station 164 as shown in FIG. 13. In one embodiment, the fanning occurs after the book block 22 undergoes a rounding process. In another embodiment, the fanning occurs before or after glue is applied to the spine of the book block 22.

The gluing station 164 applies glue to the spine of the book block 22. The gluing station 164 can include multiple vertically spaced dispensers 166 that can apply the glue to the binding as the book block 22 is passed through the gluing station 164. Depending on the thickness of the book, only a certain number of the vertically spaced dispensers 166 will be used. For example, if the book block 22 is fairly thin only the first two (lower) dispensers 166 will be required to apply the requisite amount of glue on the spine of the book block 22. Alternatively, if the book block 22 is thick, all the vertical glue dispensers 166 can be used to spray an adequate amount of glue on the spine of the book block 22.

After the glue is applied to the spine of the book block 22, the book block 22 is subjected to a rounding process. The rounding process causes the spine of the book block 22 to be rounded outwards and the front end 28 of the book block 22 to be rounded inward. The rounding process can incorporate a spine rounder 168 with a pair of rollers 170 that the book block 22 is forced between. The pair of rollers 170 are motorized to pull the outer pages (front and back) forward a little more than the pages in the middle by compressing the rolling the book block 22, which rounds the spine of the book block 22. The distance between the pair of rollers 170 can be adjusted to accommodate various sized book blocks 22.

From the pair of rollers 170, the book block 22 is deposited into a chute 172 that delivers it to a head and tail bands station 174 where a tailband and a headband are applied to the ends of the spines of the book blocks 22. The headband and tailbands are colored stitching on the ends of the spine of a book. The head and tail bands station 174 includes a wall slide(s) 176 to secure the book block 22 against a lower part 178 of the chute 172. Banding wheels 180 provide banding under a base plate 182 the book block 22 is disposed on. The banding that is guided under the base plate 182 with various equipment known in the art (such as guides, pulleys, etc.) and can be pulled across the spine of the book block 22 with a pulling apparatus 184 that can grasp the banding and pull the banding. The pulling apparatus 184 can have pinchers to grab the banding and cylinders to move the pinchers back and forth the required distance to put the banding in the correct position relative to the book block 22. The pulling apparatus 184 can have multiple pinchers and cylinders to be able to apply the banding to the head and tail parts of the spine. Excess materials used for the headbands and tailbands are cut off and discarded.

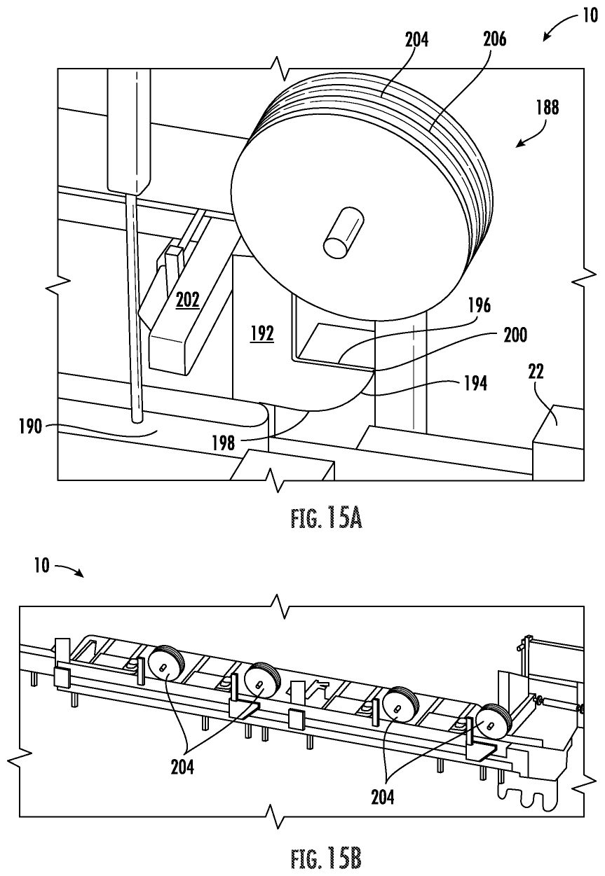

Referring now to FIGS. 15a-16, the book production system 10 can also include a ribbon inserting apparatus 186 for attaching at least one bookmark ribbon to the book block 22. The ribbon inserting apparatus 186 of the book production system 10 can be configured to add multiple bookmark ribbons to the book block 22. Each bookmark ribbon can be inserted into the book block 22 via a ribbon insertion station 188. The ribbon inserting apparatus 186 can include a side conveyor 190 for pushing the book block 22, now positioned on the spine of the book block 22, through the ribbon inserting apparatus 186 to deliver the book block 22 to each ribbon insertion station 188. Each ribbon insertion station 188 can include a plate 192 with an engagement edge 194 for contacting a specific point on the bottom end 32 or the top end 30 of the book block 22 to open the book block 22 to a specific location in the book block 22 for insertion of a bookmark ribbon. The plate 192 can be moved laterally across a cross member 202 that supports the plate 192. The engagement edge 194 of the plate 192 can have a flat top portion 196 and a curved bottom portion 198 that cooperates to create an end point 200 to facilitate efficient opening of the book block 22.

Once the book block 22 is opened, the book block 22 is conveyed to another part of the ribbon insertion station 188. This part of the ribbon insertion station 188 includes a wheel apparatus 204 with radial slots 206 disposed therein for holding various color ribbon. The ribbon can extend from the slots 206 in the wheel apparatus 204 to a support member 208 with slits 210 disposed therein for holding the ends of the ribbon prior to actual insertion of the ribbon. The support member 208 can be moved laterally to position the slit 210 holding the desired color of ribbon in the correct position relative to the book block 22 to properly insert the ribbon. The ribbon insertion station 188 can include a clasping device 212 that is slidably supported by a support rail 214 and can move towards and away from the wheel apparatus 204 via the clasping device's slidable relationship with the support rail 214. The clasping device 212 can slide towards the slits 210 in the support member 208 and clasp the end of a desired piece of ribbon. The clasping device 212 can then move away from the support member 208, which pulls a section of ribbon laterally and holds the section of ribbon in place. Lower ends 216a and 216b of arms 218a and 218b securely support the section of ribbon. A cutter 220 cuts the section of ribbon between the arm 218b and the support member 208. The arms 218a and 218b can then be lowered towards the open book block 22 to place the ribbon in the desired location. The arms 218a and 218b can be supported by the support rail 214. The clasping device 212 and the arms 218a and 218b can be driven by any mechanical means known in the art. The book block 22 can then be conveyed to a glue roller 224 to apply glue to the spine of the book block 22 and, in certain scenarios, to a second roller 226 to engage one end of the ribbons inserted in the book block 22 and press them into the glue that had been applied to the spine of the book block 22 by the glue roller 224. In certain embodiments, the glue roller 224 may be capable of engaging one end of the ribbons, applying glue to the spine of the book block 22 and glue the ends of the ribbons to the spine.

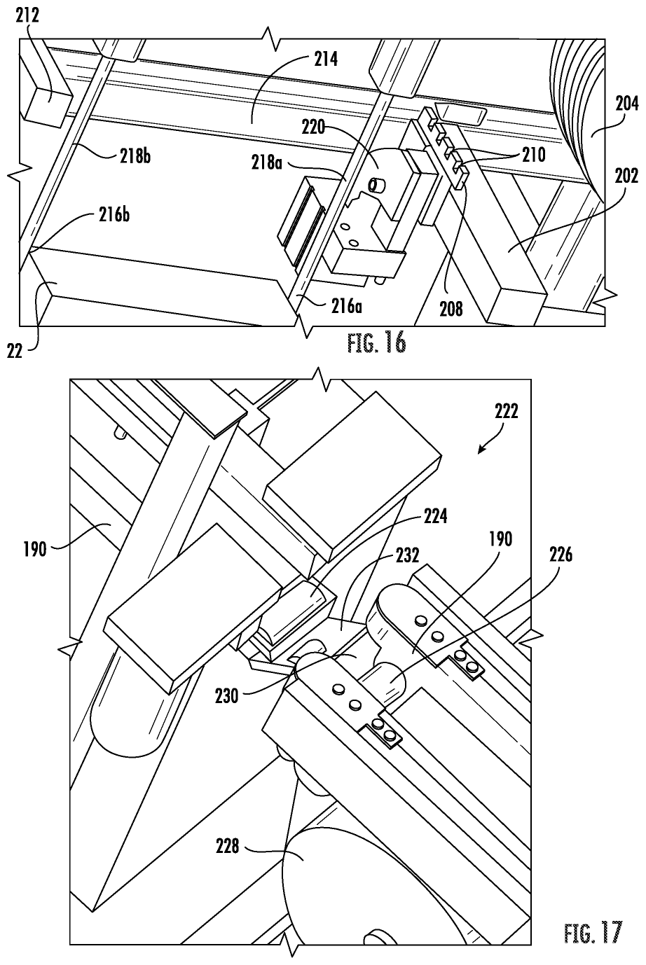

Referring now to FIG. 17, the book production system 10 then conveys the book block 22 to a mesh cover station 222 where a mesh cover is adhered to the book block 22. The book block 22 is conveyed to the mesh cover station 222 from the ribbon insertion station 188. The mesh cover station 222 cuts a piece of mesh to a certain size based on the size of the book block 22 to cover the book block 22 and have a desired amount of overhang. The mesh cover can be disposed on a mesh supply device 228 (such as a wheel) that can feed the mesh cover to the book block 22 through an opening 230 in the conveyor 190. The second roller 226 can also be used to force the mesh cover onto the glue on the spine of the book block 22. Once enough mesh cover material is supplied and glued to the spine of the book block 22, a blade 232 can be used to cut the mesh cover material.

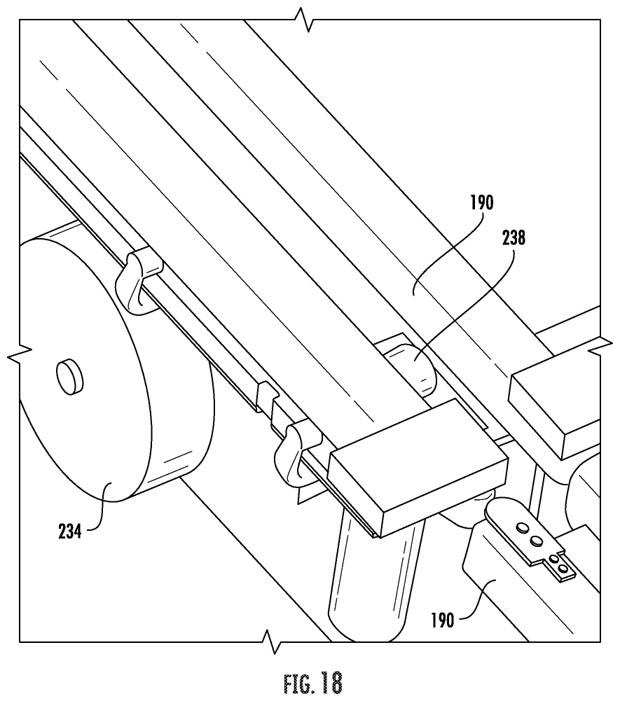

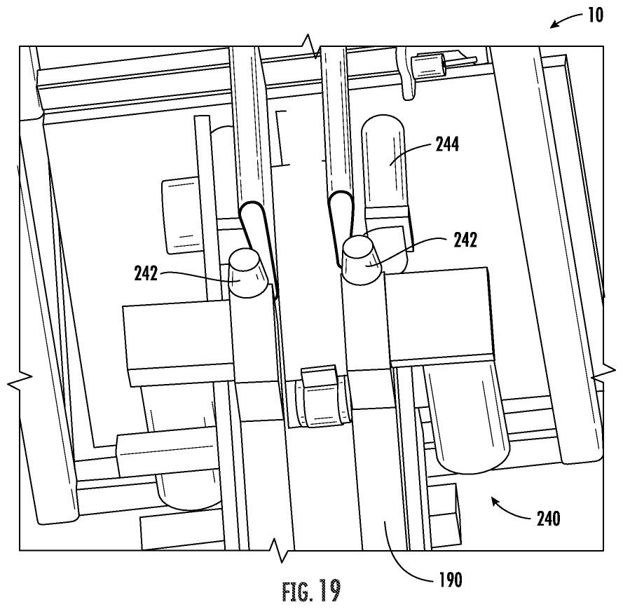

Referring now to FIG. 18, the book block finishing section 12 of the book production system 10 can also generate a book hollow that adheres to the book block 22 and the book cover to maintain the structural relationship between the spine of the book block 22 and the spine of the book cover. The book hollow is created by taking a sheet of material that has two folds along its length that create a center portion and two flaps. The two flaps are glued together to create a hollow tube that has a cross-sectional shape of a lens. One side of the lens-shaped hollow can be glued to the spine of the book block and one side of the lens-shaped hollow is glued to the inside of the spine of the book cover. In one embodiment, the flaps side of the lens-shaped hollow is glued to the spine of the book block. The book hollow material can be held on a supply device 234, such as a wheel or container that holds the book hollow material, that feeds the material to an opening 236 in the conveyor 190 where the book hollow material is secured to the spine of the book block 22 after the book block 22 has another coat of glue applied by a second glue roller 238 disposed in the conveyor 190.

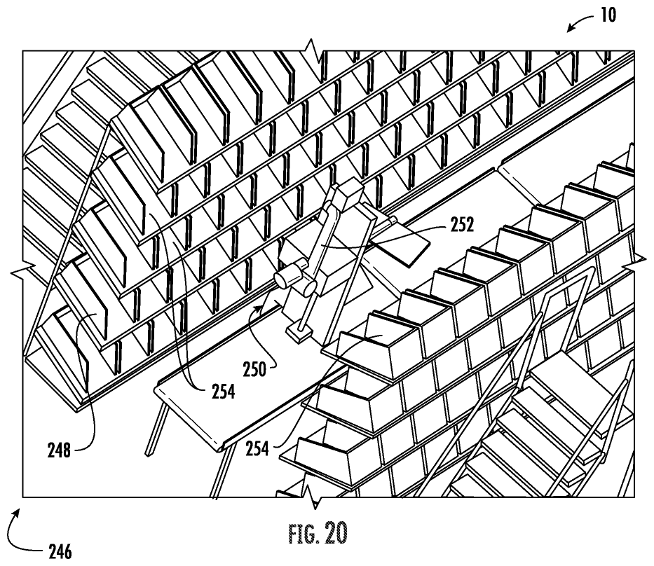

In one embodiment shown in more detail in FIG. 19, the book block finishing station 12 can include a protective page removal apparatus 240 where the book block 22 is passed between rollers 242 that pull the protective pages back from the outside of the front and back of the book block. The protective page removal apparatus 240 can include cutters 244 that cut the protective pages off the book block 22. If no protective pages were ever attached to the book block 22 and the end sheets were placed inside the first and last page of the book block 22, the protective page removal apparatus 240 removes the first and last page of the book block 22 to expose the end sheets.

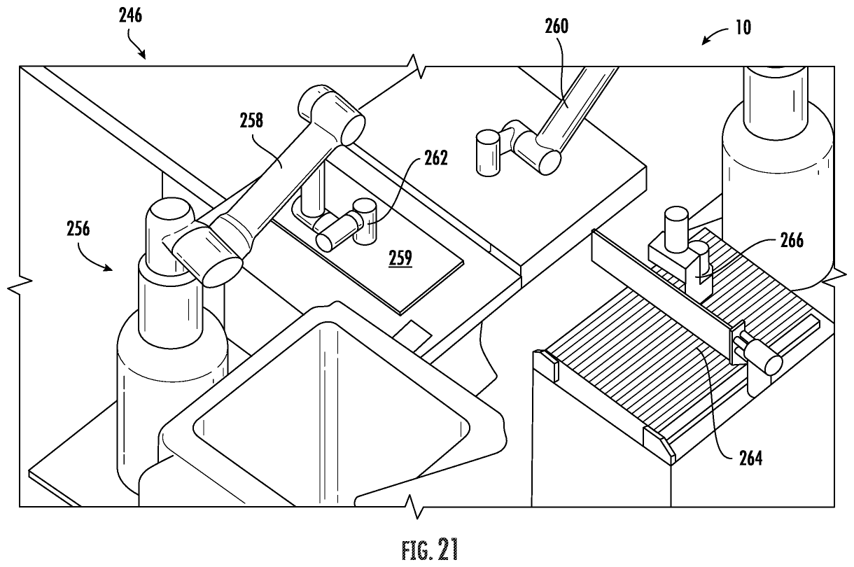

The book cover that the book block 22 can be secured to can also be generated by a cover finishing station 246 of the book production system 10. The book block 22 can be transitioned from the protective page removal apparatus 240 of the book block finishing apparatus 12 to the cover finishing station 14 via any mechanical means known in the art. Referring now to FIG. 20, the book production system 10 can select an appropriate sized piece of flexible cover material from a variety of options housed in a book cover rack 248 and a liner material from a variety of options housed in another section of the book cover rack 248. The flexible cover material and the liner material can be selected from the book cover rack 248 by an autonomous robot 250. The robot 250 can have a robotic arm 252 that retrieves the flexible cover material and the liner material from individual rack spaces 254 in the book cover rack 248. The flexible material for the flexible material cover can be any material desirable for providing a book cover, such as leather or leather-like material. The liner material is also a flexible material, such as leather or a leather-like material. The book production system 10 can use the robotic arm 252 to select the flexible material cover and the liner material. Referring now to FIG. 21, the robotic arm 252 can then deliver them to a conveyor that can deliver them to a cutting station 256 to cut them to precise dimensions based on the size of the book block, or the robotic arm 252 can deliver them directly to the cutting station 256. The cutting station 256 can have two robotic arms 258 and 260 for manipulating and cutting the flexible cover material 259 and the liner material. Either arm 258 or 260 could be used to work on the flexible cover material or the liner material.

In another embodiment, the cover can be flipped over by the robotic arm 258 or 260 whereby the cover facing upwards. The cover can be placed into a lasering machine 262, which are known in the art and can be incorporated into the robotic arms 258 or 260, to incorporate a lasered image to be displayed on the cover of the customized book, such as the title, author, name of the book owner, selected images and any other information desirable by the operators of the book production system 10 and/or the book owner. In another embodiment, before or after being sewn and with the cover facing upward, the robotic arm 258 or 260 can place the cover on a table 264 under an ultra-sonic pen 266 or alternative applicator to incorporate a customizable embossed, gilded or foiled image to be displayed on the cover of the customized book, such as the title, author, name of the book owner, selected images and any other information desirable by the operators of the book production system 10 and/or the book owner. A roller system will provide foil or gilding between the ultra-sonic pen or alternative applicator and the book cover.

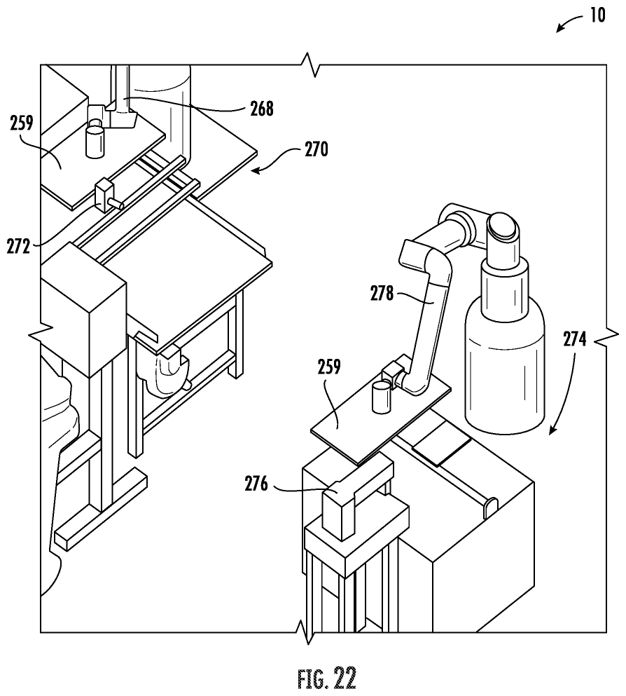

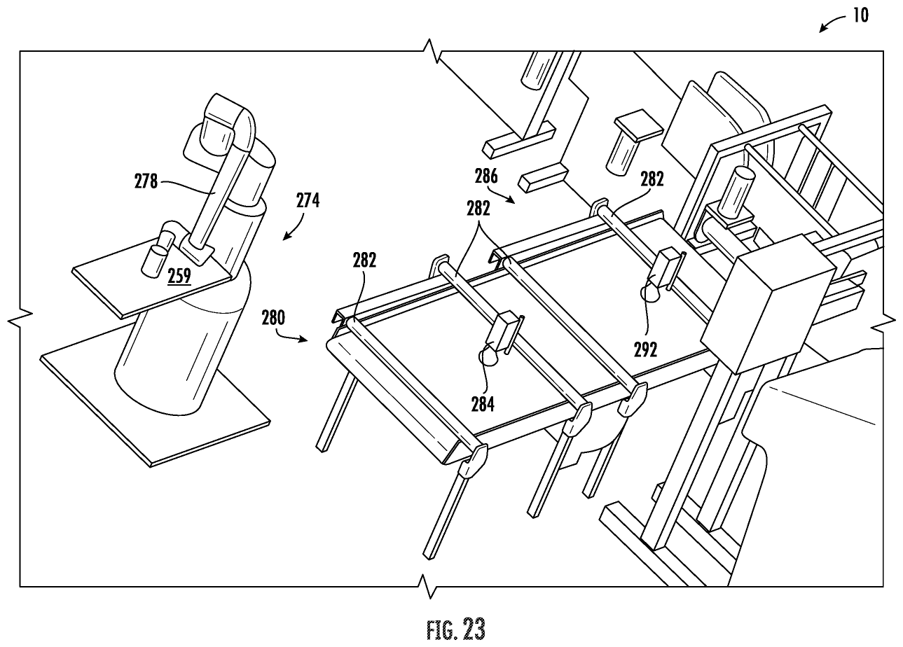

Referring now to FIG. 22, the cover can then be retrieved by another robotic arm 268 and delivered to a gluing station 270 where glue is applied by the robotic arm 268 or a dispensing machine 272 to the pre-designated areas of the cover for adherence to the liner. The liner material is then placed on top of the cover by the robotic arm 268 and pressed into place. The portions of the flexible cover material and liner left after the cutting operation occurs will be discarded or taken to a recycling process. In one embodiment, the portions of the flexible cover material and liner left after the cutting operation occurs can be retrieved by the robotic arm 258 or 260 and placed into a collection bin. Once the cover and the liner are glued together, they are sent to a sewing station 274 where a sewing machine 276 is used to sew the cover and the liner together. A robotic arm 278 can be implemented by the sewing station 274 to move and rotate the cover and liner while the two are being sewed together.

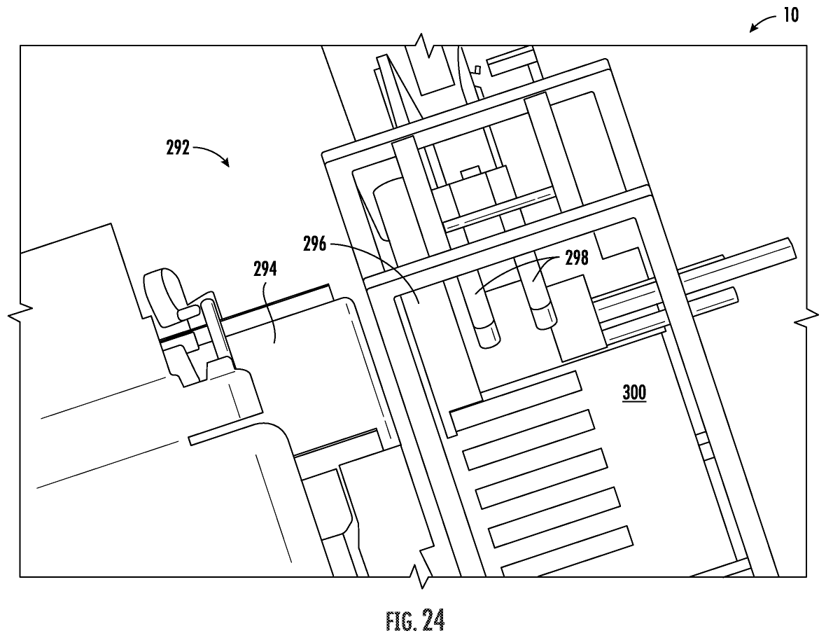

Referring now to FIG. 23, in a further embodiment of the present disclosure, the binder area of the liner can have an I-shaped cut made to it. The I-shaped cut in the liner creates a front flap and a back flap that the book production system 10 can fold upward and press back (away from the binder and cover) for insertion of the book block 22 therein. This can be accomplished by a pressing machine 280 that include auto adjusting bars 282 that guide a pressing tool 284 that engages the front and back flaps and presses them to create creases on the ends of the cover and creates inside flap portions.

The cover and liner are then delivered to a gluing apparatus 286 to provide the side flaps of the inside of the cover with glue and the liner adhered to the inside of the cover. The gluing apparatus 286 can include adjusting bars 288 that guide a glue distributor 290 in desired locations to deliver the glue to the flaps. In one embodiment, the binder area on the inside of the cover will not be glued to the liner. The liner will be sized such that there is a strip of the cover that will not be covered by the liner. In one embodiment, the strip of cover not covered by the liner will be approximately a quarter to a half inch wide. At this point, the cover will be sent back to the sewing machine 276 that will fold a portion of the outer edge of the cover back on itself and the folded back portion will be sewn to the cover. In one embodiment, the cover will be picked up by the robotic arm 278 and transported to the sewing machine 276. The edge of the liner will be sewn between the flap of the cover and the cover itself. The sewing machine 276 is capable of sewing the rounded corners due to the movement of the cover by the robotic arm 278.

In another embodiment, before or after being sewn, the cover will be flipped over and the cover facing upwards. A die will be selected to produce an embossing stamp to supply the information to be displayed on the cover of the customized book, such as corporate branding, and any other information desirable by the operators of the book production system and/or the book owner. Once the die is ready, if customer selected, a roller system will provide foil or gilding between the embossing stamp and the book cover. In certain situations, multiple colors of foil ribbon can be used to provide multiple colors of text or imagery on the cover of the customized book. The embossing stamp is heated, then pressed into the book cover to deposit the text or image on the cover. Once complete, the robotic arm returns the die to its storage area.

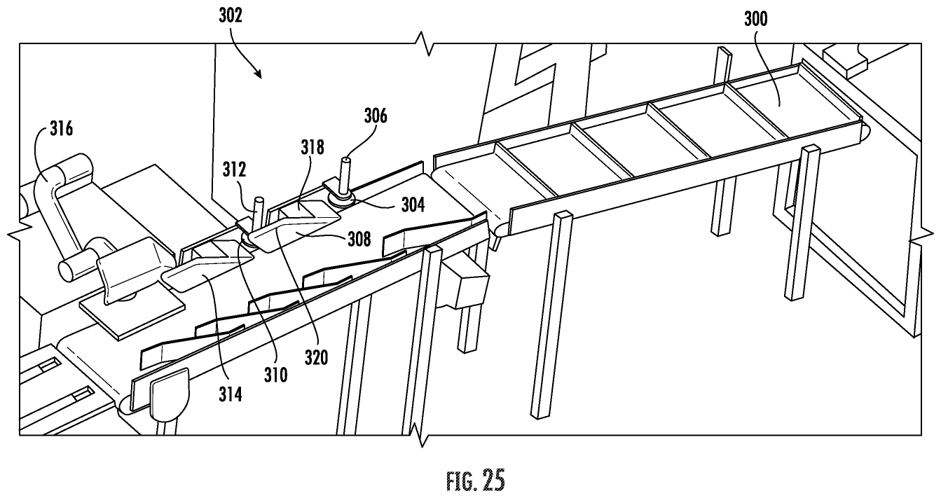

At this point, the cover can be moved back to the gluing apparatus 286 by the robotic arm 278 where the glue distributor 290 will be manipulated by its support by the adjusting bars 288 to apply glue to the inside spine portion of the cover and to the inside of the front and back flaps of the cover. Referring now to FIG. 24, the cover can then be moved to a binding machine 292 via a conveyor 294. A clamping device 296 of the binding machine 292 can engage the cover and provide it to the binding machine 292 from the conveyor 294. The cover is placed in a desired position with respect to the binding machine 292 wherein the book block 22 is suspended above the cover by a pair of clamping arms 298 that can be driven downward to force the spine of the book block 22 down into the inside spine portion of the cover where glue was previously applied. The clamping device 296 then engages one side of the cover and book block 22 to force the resulting covered book block onto its side. The covered book block is then delivered to another conveyor 300, which is part of an end sheet installer 302.

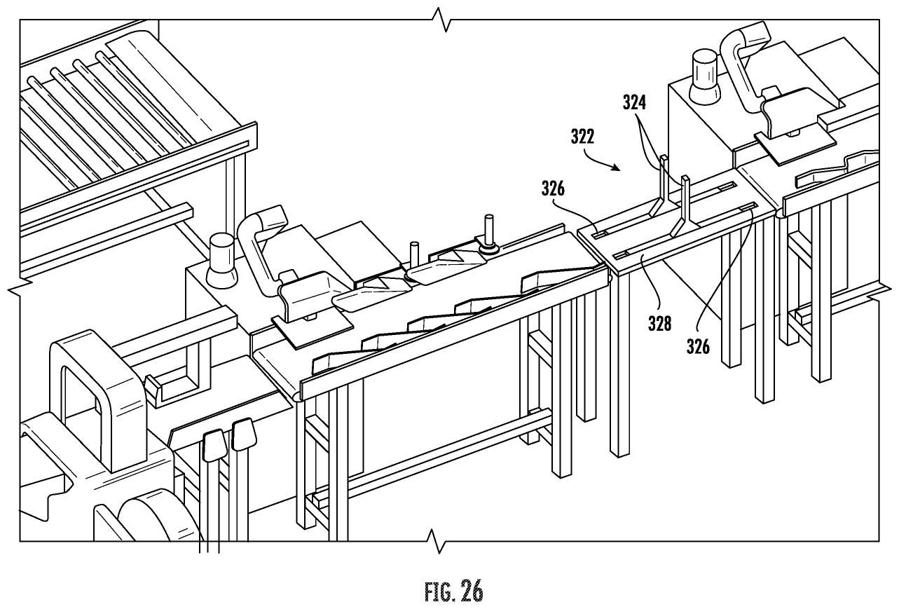

Referring now to FIGS. 25 and 26, the end sheet installer 302 can include a first suction device 304 supported by a first arm 306 that can raise and lower the first suction device 304. The first suction device 304 can raise the cover on the upside of the covered book block as it passes by on the conveyor 300. The raised part of the cover can then encounter a raised platform 308 that holds the raised part of the cover up as the covered book block is moved on the conveyor 300. A second suction device 310 engages the first page of the book block on this side and exposes the end sheet placed in this position earlier in the process by the book production system 10. Similar to the first suction device 304, the second suction device 310 can be supported by a second arm 312. The raised part of the cover and the raised first page then engage a second raised platform 314 as the covered book block moves on the conveyor 300 through the end sheet installer 302. The second raised platform 314 keeps the cover and the first page raised so that a robotic arm 316 can pick up the end sheet, apply a strip of glue to the end sheet, permit the first page to lower back into place and then apply the end sheet on top of the first page. The first and second platforms 308 and 314 both include an angled top portion 318 that angles upward in the direction the conveyor 300 is moving the covered blocks. Each platform 308 and 314 have a plate portion 320 that extend therefrom that can support at least part of the angled top portions 318. The plate portion 320 of the first raised platform 308 is positioned outside of the second suction device 310 so that the cover is not in the way and permits the second suction device 310 to engage the first page.

The conveyor 300 can then deliver the covered book blocks to a rotator device 322 to flip the covered book block over so that the other side of the covered book block can have the end sheet installed. The rotator device 322 can include multiple arms 324 for engaging and flipping the covered book block. The rotator device 322 can be disposed in openings 326 disposed in at table 328. Once the covered book block is flipped, the covered book block is conveyed to a third suction device 330 supported by a third arm 332 that can raise and lower the third suction device 330. The third suction device 330 can raise the cover on the now upside of the covered book block as it passes by on the conveyor 300. The raised part of the cover can then encounter a third raised platform 334 that holds the raised part of the cover up as the covered book block is moved on the conveyor 300. A fourth suction device 336 engages the first page of the book block on the now up side and exposes the end sheet placed in this position earlier in the process by the book production system 10. Similar to the third suction device 332, the fourth suction device 336 can be supported by a fourth arm 338. The raised part of the cover and the raised first page then engage a fourth raised platform 340 as the covered book block moves on the conveyor 300 through the end sheet installer 302. The fourth raised platform 340 keeps the cover and the first page raised so that a robotic arm 342 can pick up the end sheet, apply a strip of glue to the end sheet, permit the first page to lower back into place and then apply the end sheet on top of the first page. The first and second platforms 334 and 340 both include an angled top portion 344 that angles upward in the direction the conveyor 300 is moving the covered blocks. Each platform 334 and 340 have a plate portion 346 that extend therefrom that can support at least part of the angled top portions 344. The plate portion 346 of the third raised platform 334 is positioned outside of the fourth suction device 336 so that the cover is not in the way and permits the fourth suction device 336 to engage the first page.

Once the second end sheet is secured in the covered book block, the customized book would be complete. The book production system 10 can include other machines to facilitate packaging, boxing and shipping the customized books. It should be understood and appreciated that one of ordinary skill in the art would understand the electrical systems, motors, computer systems, machine support structures, etc. the book production system 10 would require to support the operational components described herein.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A method of making a customized book via a fully automated process, the method comprising:
producing various sized customized books via an automated book production system, the automated book production system comprising:
a book block finishing section for preparing a book block to be part of the customized book;
a cover finishing section for preparing a cover for the customized book, the cover made of a flexible material; and
a customized book finishing section that combines the book block and the cover to create the customized book.

2. The method of claim 1 wherein the book finishing block includes:
a book press for compressing the book block to remove the air from the book block;
a protective page system for installing a protective page on the book block to protect the book block during production of the customized book;
a first vacuum roller to raise an outer page on one side of the book block to facilitate insertion of a first end sheet; and
a second vacuum roller to raise a second outer page on the other side of the book block to facilitate insertion of a second end sheet.

3. The method of claim 2 wherein the book finishing block further includes:
a cutting station to cut a top edge, side edge and bottom edge of the book block to provide a uniform page size for the book block;
a page edge finishing apparatus to smooth the edges of the book block, apply gilding to the edges of the book block and apply ink to the edges of the book block; and
a ribbon insertion apparatus to insert various numbers of ribbon strips into the book block.

4. The method of claim 3 wherein the book finishing block further includes:
a corner punch station for cutting rounded corners at a first outer corner of the book block and at a second outer corner of the book block;
a gluing station for applying glue to a spine of the book block; and
a spine rounder having a pair of rollers the book block passes between that rounds the spine of the book block.

5. The method of claim 4 wherein the book finishing block further includes:
a head and tail band station for installing a head and tall band on the spine of the book block;
a mesh cover station for applying a mesh material to the spine of the book;
a page fanner to separate the pages of the book block to prevent the pages from sticking together after gilding and painting the edges; and
a protective page removal apparatus for removing protective pages from the book block in preparation for being combined with the cover.

6. The method of claim 1 wherein the cover finishing section includes:
a book cover rack for storing multiple variations of flexible cover materials in separate book cover racks;
a first robotic arm for selecting a desired flexible cover material and lining material; and
a cover cutting station for cutting the flexible cover material to a desired size to create the cover for the customized book.

7. The method of claim 6 wherein the cover finishing section includes:
a cover gluing station for gluing the cover to the lining material;
a sewing station for sewing the lining material to the cover; and
a pressing machine for folding and pressing edges of the cover to be sewn together.

8. The method of claim 7 wherein the cover finishing section includes:
a cover gluing station for gluing the cover to the lining material;
a sewing station for sewing the lining material to the cover; and
a pressing machine for folding and pressing edges of the cover to be sewn together.

9. The method of claim 1 wherein the customized book finishing section includes:
a binding machine that clamps the book block and forces the book block into the cover to create the customized book; and
an end sheet installer to install end sheets inside front and back parts of the cover.

10. The method of claim 1 further comprising the step of receiving a customized book order from a customer with customized details for the customized book.

11. A fully automated customized book production system, the system comprising:
a book block finishing section for preparing a book block to be part of the customized book;
a cover finishing section for preparing a cover for the customized book, the cover made of a flexible material; and
a customized book finishing section that combines the book block and the cover to create the customized book.

12. The system of claim 11 wherein the book finishing block includes:
a book press for compressing the book block to remove the air from the book block;
a protective page system for installing a protective page on the book block to protect the book block during production of the customized book;
a first vacuum roller to raise an outer page on one side of the book block to facilitate insertion of a first end sheet; and
a second vacuum roller to raise a second outer page on the other side of the book block to facilitate insertion of a second end sheet.

13. The system of claim 12 wherein the book finishing block further includes:
a cutting station to cut a top edge, side edge and bottom edge of the book block to provide a uniform page size for the book block;
a page edge finishing apparatus to smooth the edges of the book block, apply gilding to the edges of the book block and apply paint to the edges of the book block; and
a ribbon insertion apparatus to insert various numbers of ribbon strips into the book block.

14. The system of claim 13 wherein the book finishing block further includes:
a corner punch station for cutting rounded corners at a first outer corner of the book block and at a second outer corner of the book block;
a gluing station for applying glue to a spine of the book block; and
a spine rounder having a pair of rollers the book block passes between that rounds the spine of the book block.

15. The system of claim 14 wherein the book finishing block further includes:
a head and tail band station for installing a head and tall band on the spine of the book block;
a mesh cover station for applying a mesh material to the spine of the book;
a page fanner to separate the pages of the book block to prevent the pages from sticking together after gilding and painting the edges; and
a protective page removal apparatus for removing protective pages from the book block in preparation for being combined with the cover.

16. The system of claim 11 wherein the cover finishing section includes:
a book cover rack for storing multiple variations of flexible cover materials in separate book cover racks;
a first robotic arm for selecting a desired flexible cover material and lining material; and
a cover cutting station for cutting the flexible cover material to a desired size to create the cover for the customized book.

17. The system of claim 16 wherein the cover finishing section includes:
a cover gluing station for gluing the cover to the lining material;
a sewing station for sewing the lining material to the cover; and
a pressing machine for folding and pressing edges of the cover to be sewn together.

18. The system of claim 17 wherein the cover finishing section includes:
a cover gluing station for gluing the cover to the lining material;
a sewing station for sewing the lining material to the cover; and
a pressing machine for folding and pressing edges of the cover to be sewn together.

19. The system of claim 11 wherein the customized book finishing section includes:
a binding machine that clamps the book block and forces the book block into the cover to create the customized book; and
an end sheet installer to install end sheets inside front and back parts of the cover.

20. The system of claim 13 wherein the page edge finishing apparatus includes a carousel table that distributes the book block to finishing sections of the page edge finishing apparatus.
